(19) United States
(12) Patent Application Publication
(10) Pub. No.: US 2006/0201360 A1
(43) Pub. Date: Sep. 14, 2006

(54) Method for making a processless lithographic printing plate

(75) Inventors: Hieronymus Andriessen, Beerse (BE); Steven Lezy, Antwerpen (BE)

Correspondence Address: AGFA;c/o KEATING & BENNETT, LLP, 8180 GREENSBORO DRIVE, SUITE 850, MCLEAN, VA, 22102, US

(73) Assignee: AGFA-GEVAERT N.V.

(21) Appl. No.: 11/372,175

(22) Filed: Mar. 8, 2006

Related U.S. Application Data
(60) Provisional application No. 60/664,087, filed on Mar. 22, 2005.

(30) Foreign Application Priority Data
Mar. 14, 2005 (EP) 05101966.9

(51) Int. Cl. C25D 11/02; B41N 3/00

(52) U.S. Cl. 101/467; 205/171

(57) ABSTRACT

A method for making a negative-working, heat-sensitive printing plate precursor capable of switching from a hydrophilic state into a hydrophobic state upon exposure to heat and/or infrared light, including the steps of (i) providing a support having a surface comprising titanium, (ii) modifying the surface by producing an oxide of titanium following the steps of (1) anodizing the support and (2) annealing the anodized support under reduced pressure. Additionally, a method for making a negative-working, heat-sensitive printing plate precursor capable of switching from a hydrophilic state into a hydrophobic state upon exposure to heat and/or infrared light, including the steps of (i) providing a support having a surface including titanium, (ii) modifying the surface by producing an oxide of titanium following the steps of (1) etching the support and (2) anodizing the etched support.

### CROSS-REFERENCE TO RELATED PATENT APPLICATIONS

This application claims the benefit of U.S. Provisional Application No. 60/664,087 filed Mar. 22, 2005, which is incorporated by reference. In addition, this application claims the benefit of European Application No. 05101966.9 filed Mar. 14, 2005, which is also incorporated by reference.

### BACKGROUND OF THE INVENTION

1. Field of the Invention

The present invention relates to a method for making a negative-working, heat-sensitive printing plate precursor which is suitable for making a lithographic printing plate by direct-to-plate recording.

2. Description of the Related Art

Lithographic printing presses use a so-called printing master such as a printing plate which is mounted on a cylinder of the printing press. The master carries a lithographic image on its surface and a print is obtained by applying ink to the image and then transferring the ink from the master onto a receiver material, which is typically paper. In conventional, so-called “wet” lithographic printing, ink as well as an aqueous fountain solution (also called dampening liquid) are supplied to the lithographic image which consists of oleophilic (or hydrophobic, i.e., ink-accepting, water-repelling) areas as well as hydrophilic (or oleophobic, i.e., water-accepting, ink-repelling) areas. In so-called driographic printing, the lithographic image consists of ink-accepting and ink-abhesive (ink-repelling) areas and during driographic printing, only ink is supplied to the master.

Printing masters are generally obtained by the image-wise exposure and processing of an imaging material called a plate precursor. In addition to the well-known photosensitive, so-called pre-sensitized plates, which are suitable for UV contact exposure through a film mask, heat-sensitive printing plate precursors have also become very popular in the late 1990s. Such thermal materials offer the advantage of daylight stability and are especially used in the so-called computer-to-plate method wherein the plate precursor is directly exposed, i.e., without the use of a film mask. The material is exposed to heat or to infrared light and the generated heat triggers a (physico-)chemical process, such as ablation, polymerization, insolubilization by cross linking of a polymer, heat-induced solubilization, or by particle coagulation of a thermoplastic polymer latex.

The most popular thermal plates form an image by a heat-induced solubility difference in an alkaline developer between exposed and non-exposed areas of the coating. The coating typically includes an oleophilic binder, e.g., a phenolic resin, of which the rate of dissolution in the developer is either reduced (negative working) or increased (positive working) by the image-wise exposure. During processing, the solubility differential leads to the removal of the non-image (non-printing) areas of the coating, thereby revealing the hydrophilic support, while the image (printing) areas of the coating remain on the support. Typical examples of such plates are described in, e.g., EP 625 728, EP 823 327, EP 825 927, EP 864 420, EP 894 622 and EP 901 902. Negative working embodiments of such thermal materials often require a pre-heat step between exposure and development as described in, e.g., EP 625 728.

Some of these thermal processes enable plate making without wet processing and are, for example, based on ablation of one or more layers of the coating. At the exposed areas the surface of an underlying layer is revealed which has a different affinity towards ink or fountain solution than the surface of the unexposed coating, thus the image (printing) and non-image or background (non-printing) areas are obtained.

U.S. Pat. No. 5,605,780 discloses a lithographic printing plate including an anodized aluminum support and an image-forming layer including an IR absorbing agent and a cyanoacrylate polymer binder provided on the anodized aluminum support. The image-forming layer is removed by laser-induced thermal ablation whereby the underlying hydrophilic support is revealed.

EP 580 393 discloses a lithographic printing plate directly imageable by laser discharge, the plate including a topmost first layer and a second layer underlying the first layer wherein the first layer is characterized by efficient absorption of infrared radiation and the first and second layer exhibit different affinities for at least one printing liquid.

EP 1 065 051 discloses a negative-working heat-sensitive material for making lithographic plates including, in the order given, a lithographic base having a hydrophilic surface, an oleophilic imaging layer and a cross-linked hydrophilic upper layer. The heat generated during exposure in the light-sensitive layer removes the hydrophilic upper layer by ablation.

Most ablative plates generate ablation debris which may contaminate the electronics and optics of the exposure device and which needs to be removed from the plate by wiping it with a cleaning solvent, so that ablative plates are often not truly processless. Ablation debris which is deposited onto the plate's surface may also interfere during the printing process and result in, for example, scumming.

Other thermal processes which enable plate making without wet processing are, for example, processes based on a heat-induced hydrophilic/oleophilic conversion of one or more layers of the coating so that at exposed areas a different affinity towards ink or fountain solution is created than at the surface of the unexposed coating.

U.S. Pat. No. 5,855,173, U.S. Pat. Nos. 5,839,369 and 5,839,370 describe a method relying on the image-wise hydrophilic-hydrophobic transition of a ceramic such as a zirconia ceramic and the subsequent reverse transition in an image erasure step. This image-wise transition is obtained by exposure to infrared laser irradiation at a wavelength of 1064 nm at high power which induces local ablation and formation of substoichiometric zirconia. U.S. Pat. No. 5,893,328, U.S. Pat. No. 5,836,248 and U.S. Pat. No. 5,836,249 disclose a printing material including a composite of zirconia alloy and α-alumina which can be imaged using similar exposure means to cause localized “melting” of the alloy in the exposed areas and thereby creating hydrophobic/oleophilic surfaces. A similar printing material containing an alloy of zirconium oxide and Yttrium oxide is described in U.S. Pat. No. 5,870,956. The high laser power output required in these prior art methods requires the use of expensive exposure devices.

EP 1 002 643 discloses a printing plate including an anodized titanium metal sheet which becomes hydrophilic or ink-repellent upon image-wise exposure to actinic light. The printing plate can be regenerated after printing by first cleaning the plate and subsequently subjecting the plate to a heat-treatment step whereby the plate surface becomes evenly oleophilic or ink-accepting.

EP 958 941 discloses a plate precursor having a surface layer including Si₃N₄ and/or BN on which an image can be formed after image-wise exposure of the layer to light.

U.S. Pat. No. 6,240,091 discloses a method of producing a lithographic printing plate by image-wise irradiation of a printing plate precursor which includes a support having a hydrophilic, metallic compound layer with photo-catalytic properties and light-heat convertible minute particles onto the layer, whereby the polarity of the metallic layer is converted and a hydrophobic area is obtained.

U.S. Pat. No. 6,455,222 discloses lithographic printing plate precursors including light-heat convertible particles with a hydrophilic surface such as inorganic metal oxides including TiOₓ, SiOₓ and AlOₓ. Upon heat exposure of the particles, the surface is converted from a hydrophilic state to a hydrophobic state.

EP 903 223 discloses a lithographic printing method using a printing plate precursor including a surface having a thin layer of TiO₂, ZnO, SnO₂, Bi₂O₃, Fe₂O₃ or a compound selected from the group consisting of RTiO₃ wherein R represents an alkaline earth metal atom, AB₂₋ₓCₓD₃₋ₓEₓO₁₀ wherein A represents a hydrogen atom or an alkali metal atom; B represents an alkaline earth metal atom or a lead atom; C represents a rare earth atom; D represents a metal atom of the group 5A of the Periodic Table; E represents a metal atom of the group 4A of the Periodic Table; and x represents a number from 0 to 2. The exposure step with actinic light through a film mask renders the surface hydrophilic at the exposed areas and subsequent heating results in a hydrophilic/hydrophobic conversion.

U.S. Pat. No. 6,455,222 discloses a lithographic printing plate precursor including fine hydrophilic light-heat convertible particles such as inorganic metal oxides including TiOₓ (x=1.0-2.0), SiOₓ (x=0.6-2.0) and AlOₓ (x=1.0-2.0) which are converted from a hydrophilic state into a hydrophobic state by the action of heat.

A major problem associated with the prior art materials based on metal oxides is that these materials require exposure with high power laser light and/or the use of expensive exposure devices. Other plates based on metal oxides have to undergo a photo-reduction reaction prior to their use to induce a hydrophobic/hydrophilic conversion. This photo-reduction reaction can be initiated by, for example, a pre-heat treatment step and/or a flood UV-exposure step which have to be performed by the end-user. Such pre-treatment steps make plate making a cumbersome process.

### SUMMARY OF THE INVENTION

In order to overcome the problems described above, preferred embodiments of the present invention provide a method for making a negative-working, heat-sensitive lithographic printing plate precursor which requires no processing step and which can be directly exposed to heat and/or light via a laser with low power output and without the need for a flood UV-exposure pre-treatment.

According to the present preferred embodiment, there is provided a method for making a negative-working, heat sensitive lithographic printing plate precursor including the steps of:
(i) providing a support having a surface including titanium; and
(ii) modifying the surface by producing a hydrophilic oxide of titanium by the steps of:
   1) anodizing the surface; and
   2) annealing the anodized surface under reduced pressure;
      wherein the oxide of titanium is capable of switching from a hydrophilic state to a hydrophobic state upon exposure to heat and/or infrared light.

According to another preferred embodiment of the present invention, there is also provided another method for making a negative-working, heat sensitive lithographic printing plate precursor including the steps of:
(i) providing a support having a surface including titanium; and
(ii) modifying the surface by producing a hydrophilic oxide of titanium by the steps of:
   1) etching the surface; and
   2) anodizing the etched surface;
      wherein the oxide of titanium is capable of switching from a hydrophilic state into a hydrophobic state upon exposure to heat and/or infrared light.

According to another preferred embodiment of the present invention, there is further provided a method for making a lithographic printing plate including the steps of:
(i) providing a lithographic printing plate precursor according to a preferred embodiment above;
(ii) image-wise exposing the precursor to heat and/or infrared light whereby the surface of the precursor switches from a hydrophilic state to a hydrophobic state at exposed areas.

According to another preferred embodiment of the present invention, there is further provided a method of printing including the steps of:
(i) providing a lithographic printing plate carrying on the surface a lithographic image according to the method described above;
(ii) producing a plurality of printed copies by supplying ink to the printing plate and transferring the ink to paper;
(iii) optionally cleaning the printing plate by removing the ink from the plate;
(iv) erasing the lithographic image by flood-exposing the printing plate to UV light thereby converting hydrophobic areas of the surface to a hydrophilic state; and
(v) re-using the precursor thus obtained in a next cycle including the steps (i) to (iv).

Other features, elements, steps, characteristics and advantages of the present invention will become more apparent from the following detailed description of preferred embodiments of the present invention.

### DETAILED DESCRIPTION OF PREFERRED EMBODIMENTS

According to the method of at least one of the preferred embodiments of the present invention, a printing plate precursor having a support with a surface including titanium is converted from a hydrophobic state into a hydrophilic state by first anodizing and than annealing the surface under reduced pressure. Alternatively, a printing plate precursor having a support with a surface including titanium is converted from a hydrophobic state into a hydrophilic state by first etching the support followed by an anodizing step. By irradiation of the hydrophilized surface with heat and/or infrared light, a switch from a hydrophilic state into a hydrophobic state is obtained.

The support of the printing plate precursor having a surface including titanium is preferably a titanium metal sheet. Alternatively, the support is a base onto which a thin layer of titanium metal is applied.

The titanium metal sheet may be a commercially available titanium metal sheet having preferably about 99.5% wt to about 99.9% wt purity. Also suitable is an alloy of titanium containing about 4% wt to about 5% wt of for example aluminum, vanadium, manganese, iron, chromium and molybdenum. The thickness of the titanium metal sheet is not critical: it may be between about 0.05 mm to about 0.6 mm, preferably from about 0.05 mm to about 0.4 mm, and more preferably from about 0.1 mm to about 0.3 mm.

The base onto which a thin layer of titanium is applied may be a metal sheet including, for example, aluminum, stainless steel, nickel, and copper. Also suitable as a base is a flexible plastic support such as polyester or cellulose ester, waterproof paper, polyethylene-laminated paper, or polyethylene-impregnated paper. The support can also be a laminate including an aluminum foil and a plastic layer, e.g., polyester film.

When a metal sheet is used as a base for the titanium layer, the surface of the metal base may have been roughened by any of the known methods. The surface roughening may be mechanical, electrochemical, or chemical etching, or by combinations of these methods.

A particularly preferred lithographic support is an electrochemically grained and anodized aluminum support. The grained and anodized aluminum support is preferably grained by electrochemical graining, and anodized via anodizing techniques employing phosphoric acid or a sulphuric acid/phosphoric acid mixture. Methods of both graining and anodization of aluminum are very well known in the art.

By varying the type and/or concentration of the electrolyte and the applied voltage in the graining step, different types of grains can be obtained.

By anodizing the aluminum support, its abrasion resistance and hydrophilic nature are improved. The microstructure as well as the thickness of the Al₂O₃ layer are determined by the anodizing step, the anodic weight (g/m² Al₂O₃ formed on the aluminum surface) varies between about 1 g/m² and about 8 g/m².

The thin layer of titanium present on the base may be applied by known methods such as for example vapor deposition, spray pyrolysis, sputtering, or electrodeposition. The thickness of the deposited titanium metal layer is preferably from about 0.01 μm to about 10 μm, more preferably from about 0.05 μm to about 1.0 μm, and most preferably the thickness varies between about 0.10 μm and about 0.30 μm.

The titanium sheet or the base provided with a titanium layer may be subjected to a surface roughening step treatment prior to the anodization step. Preceding the surface-roughening step, a degreasing step may be conducted with for example a surfactant, an organic solvent or an aqueous alkali solution.

The surface roughening treatment of the titanium sheet or the base provided with a titanium layer can be conducted by various methods; examples thereof include mechanically roughening (e.g., grinding with balls, brushing, blasting, or buffing), electrochemical dissolution (e.g., surface roughening in an electrolytic solution with application of an AC or DC current) or chemical dissolution (e.g., immersing the metal in an aqueous solution of one or more alkaline salts selected from sodium hydroxide, sodium carbonate, sodium silicate or sodium pyrophosphate). These methods may be used alone or in combination.

According to a preferred method of the present invention, the anodization of titanium is performed by treatment of the surface including titanium with an aqueous electrolyte solution at a concentration of about 0.001 mol/l to about 5 mol/l, preferably from about 0.005 mol/l to about 3 mol/l, a liquid temperature of about 5° C. to about 70° C., preferably from about 15° C. to about 30° C., a DC voltage of about 1 V to about 100 V, preferably about 5 V to about 50 V, more preferably about 10 V to about 30 V, and an electrolysis period of about 10 seconds to about 10 minutes, preferably about 1 minute to about 8 minutes.

More preferably, the surface of the support is anodized in an aqueous electrolyte solution containing at least one of the following chemicals:
an inorganic acid selected from sulfuric acid, phosphoric acid, nitric acid or boric acid;
hydrogen peroxide in addition to one or more of the above inorganic acids;
an alkali metal salt and/or an alkaline earth metal salt of the above inorganic acids;
an organic acid selected from oxalic acid, tartaric acid, citric acid, acetic acid, lactic acid, succinic acid, glutamic acid, sulfosalicyclic acid or naphthalenedisulfonic acid;
an alkali metal salt and/or an alkaline earth metal salt of the above organic acids;
hydroxides and/or water-soluble carbonates of sodium, potassium, calcium, lithium, and magnesium and/or aqueous alkali solutions such as ammonium hydroxide solution;
glycerophosphoric acid and the alkali metal salt and/or the alkaline earth metal salt thereof and/or acetic acid and the alkali metal salt and/or the alkaline earth metal salt thereof.

These aqueous electrolyte solutions may be used alone or in combination. The concentration of the solutions depends on the kind of the electrolyte used for the anodization process.

In an example of a preferred embodiment of the present invention, the electrolyte solution preferably includes oxalic acid at a concentration of about 0.6 mol/l, and the anodizing reaction is carried out at room temperature using about 20 V DC for a period of about 5 minutes.

Doping the anodized surface with a metal such as platinum, palladium, gold, silver, copper, nickel, iron, or cobalt or a mixture thereof may be advantageous.

According to the method of the first preferred embodiment of the present invention, the anodized support is annealed at a reduced atmospheric pressure. Other gasses such as H₂ or N₂ gas may be used during the annealing step.

Preferably, the annealing temperature varies between about 350° C. and about 550° C., more preferably between about 400° C. and about 500° C., and the annealing time varies between about 60 minutes and about 240 minutes, more preferably between about 80 and about 200 minutes. The pressure applied during the annealing step varies between about 0.1 kPa (1 mBar) and about 1 kPa (10 mBar), and more preferably between about 0.2 kPa (2 mBar) and about 0.6 kPa (6 mBar).

According to the method of the second preferred embodiment of the present invention, prior to the anodization step, the support is etched. Etching of metal surfaces can be done in many ways. For example, aqueous solutions including one or more alkaline salts can be used. In an example of the present preferred embodiment, a mixture including H₂O₂ and NaOH is used wherein the concentration of H₂O₂ varies between about 0.05 mol/l and about 1 mol/l, more preferably between about 0.1 mol/l and about 0.8 mol/l and the concentration of NaOH varies between about 0.1 mol/l and about 5 mol/l, more preferably between about 0.5 mol/l and about 3.5 mol/l. The etching temperature varies preferably between about 50° C. and about 100° C., more preferably between about 60° C. and about 80° C. and the reaction time varies preferably between about 0.5 minute and about 10 minutes, more preferably between about 0.5 minute and about 5 minutes. Alternatively, the etching and anodizing steps may be carried out in one step. The etched and anodized printing plate precursor may optionally undergo further post-treatments such as chemical reducing treatments, e.g., annealing at reduced pressure as defined in the first method, or photolytic reduction, e.g., UV-treatment.

The lithographic printing plate precursor including an anodized and annealed support or including an etched and anodized support thus obtained, may be rinsed with water, with a liquid containing a surfactant or with a desensitizing liquid (so called gum solution) containing gum arabic or a starch derivative, or with combinations thereof.

The surface of the printing plate precursor is hydrophilic and upon image-wise exposure to heat and/or light, the exposed areas become ink accepting. This conversion from a hydrophilic to a hydrophobic state can, for example, be characterized by an increase of the contact angle for water measured on the surface: the contact angle for water increases after the treatment of the support indicating a hydrophilic/hydrophobic conversion. The contact angle is defined as the angle between the tangent of the edge of the water droplet at the contact zone between the support and the droplet.

A layer which includes a compound capable of absorbing light and converting the absorbed energy into heat may optionally be coated onto the anodized and annealed support or onto the etched and anodized support. The compound capable of absorbing light and converting it into heat is preferably an infrared absorbing agent. Preferred IR absorbing compounds are dyes such as cyanine, merocyanine, indoaniline, oxonol, pyrilium and squarilium dyes or pigments such as carbon black. Examples of suitable IR absorbers are described in, e.g., EP 823 327, EP 978 376, EP 1 029 667, EP 1 053 868, EP 1 093 934, WO 97/39894 and WO 00/29214. A preferred compound is the following cyanine dye IR-A: 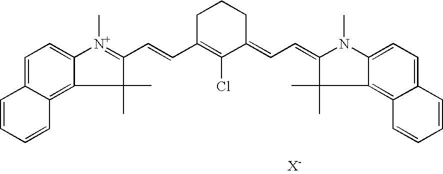
wherein X⁻ is a suitable counter ion such as tosylate.

The coating may in addition to the layer including the infrared absorbing agent also contain one or more additional layer(s) such as, i.e., a protective layer or an adhesion-improving layer between the layer including the infrared absorbing agent and the support.

Optionally, the layer including a compound capable of absorbing light or an optional other layer may further contain additional ingredients. For example, binders, surfactants such as perfluoro surfactants, silicon or titanium dioxide particles or colorants may be present.

According to the present preferred embodiment, the heat-sensitive printing plate precursor thus obtained is then image-wise exposed directly with heat or indirectly with infrared light, preferably near infrared light. The infrared light is preferably converted into heat by an IR light absorbing compound as discussed above. The printing plate precursor is not sensitive to ambient light so that it can be handled without the need for a safe light environment.

The printing plate precursor can be exposed to infrared light via, e.g., LEDs or an infrared laser. Preferably, the light used for the exposure is a laser emitting near infrared light having a wavelength in the range from about 700 nm to about 1500 nm, e.g., a semiconductor laser diode, a Nd:YAG or a Nd:YLF laser.

The exposure step may optionally be followed by a rinsing step and/or a gumming step. The gumming step involves post-treatment of the heat-sensitive printing plate with a gum solution. A gum solution is typically an aqueous liquid which includes one or more surface protective compounds that are capable of protecting the lithographic image of a heat-sensitive material or printing plate against contamination or damaging. Suitable examples of such compounds are film-forming hydrophilic polymers or surfactants.

According to the present preferred embodiment, the heat-sensitive printing plate is then ready for printing without an additional development step. The exposed plate can be mounted on a conventional, so-called wet offset printing press in which ink and an aqueous dampening liquid are supplied to the material. The non-image areas hold the dampening water and the image areas hold the ink.

Another suitable printing method uses so-called single-fluid ink without a dampening liquid. Suitable single-fluid inks have been described in U.S. Pat. No. 4,045,232, U.S. Pat. No. 4,981,517 and U.S. Pat. No. 6,140,392. In an example of the present preferred embodiment, the single-fluid ink includes an ink phase, also called the hydrophobic or oleophilic phase, and a polyol phase as described in WO 00/32705.

Alternatively, the printing plate is first mounted on the printing cylinder of the printing press and then image-wise exposed directly on the press via an integrated image-recording device. Subsequent to exposure, the plate is ready for printing.

The printing plate can be regenerated after printing. After printing, the printing plate is subjected to a flood exposure with UV light whereby hydrophobic areas are converted to a hydrophilic state and recover sensitivity to infrared light and/or heat irradiation. Optionally, before the flood exposure step, a cleaning step may be performed to remove the adherent ink. Suitable solvents that can be used for cleaning include hydrophobic petroleum solvents such as aromatic hydrocarbons commercially available as printing ink solvents: kerosine, benzol, toluol, xylol, acetone, methyl ethyl ketone, and mixtures thereof.

The regenerated printing plate precursor thus obtained can be used for a next printing operation involving image-wise exposure and printing.

### EXAMPLES

### Example 1

A titanium foil (Goodfellow TI000380 99.6%, 125 μm foil) was cleaned by ultrasound treatment in isopropanol and was subsequently rinsed with water.

Samples with a size of 19 cm×5.5 cm were cut out of the cleaned titanium support and anodized using a counter electrode of titanium and a distance between the two electrodes of 2.4 cm. Table 1 lists the different anodizing conditions. Printing plate precursors 1 and 3 were anodized in one single step whereas printing plate precursor 2 was anodized in three subsequent steps. Every anodizing step was followed by a rinsing step with water.

TABLE 1
Anodizing conditions.

| | Anodizing conditions | | | |
|---|---|---|---|---|
| | Anodizing | | | |
| | solution in | | | |
| Printing plate | water | | Time | Temp* |
| precursor (PPP) nr. | mol/l | DC Voltage V | min | ° C. |
| PPP 1 | H₂SO₄ 2 | 20 | 5 | RT |
| PPP 2 | NaOH 0.2 | 20 | 5 | RT |
| | H₂SO₄ 0.2 | 20 | 5 | RT |
| | NaOH 0.2 | 20 | 5 | RT |
| PPP 3 | Oxalic acid 0.6 | 20 | 5 | RT |

*RT = room temperature

The precursors subsequently underwent two different annealing treatments in air at a reduced pressure:
1) 0.21-0.5 kPa at 430° C. during 90 minutes and
2) 0.21-0.5 kPa at 430° C. during 180 minutes.

The thus obtained printing plate precursors 1, 2 and 3 were subsequently irradiated with a single beam IR-laser diode at 830 nm with a pitch of 7 μm at 280 mW at 4 m/s (corresponding to an energy density of 1000 mJ/cm²) and with a single beam IR-laser diode at 830 nm with a pitch of 7 μm at 280 mW at 8 m/s (corresponding to an energy density of 500 mJ/cm²).

After irradiation, the contact angles of the printing plates 1, 2 and 3 were measured with a water droplet utilizing a FIBRO DAT1100 equipment (trademark of FIBRO system AB). The contact angles were measured 2 ms after the deposition of the water droplet and are summarized in Table 2.

TABLE 2
Contact angles before and after the annealing step.

| Printing plate | | |
|---|---|---|
| nr. | Annealing step | Contact angle |
| Printing plate 1 | No annealing | 50° |
| Comparative | | |
| Inventive | 90 min, 430° C., 0.21-0.5 kPa | 33° |
| Inventive | 180 min, 430° C., 0.21-0.5 kPa | 38° |
| Printing plate 2 | No annealing | 51° |
| Comparative | | |
| Inventive | 90 min, 430° C., 0.21-0.5 kPa | 34° |
| Inventive | 180 min, 430° C., 0.21-0.5 kPa | 31° |
| Printing plate 3 | No annealing | 42° |
| Comparative | | |
| Inventive | 90 min, 430° C., 0.21-0.5 kPa | 28° |
| Inventive | 180 min, 430° C., 0.21-0.5 kPa | 27° |

The results of Table 2 indicate that the annealing step under reduced pressure of the printing plate precursors results in a lowering of the contact angle value.

Upon laser irradiation of printing plate precursor 3 (non annealed sample and annealed sample), printing plate 3 is obtained of which the contact angle remains the same for the non-annealed plate and increases for the annealed plates indicating a hydrophilic/hydrophobic switch (Table 3).

TABLE 3
Contact angles after laser irradiation.

| | | Contact angle | |
|---|---|---|---|
| | | after IR-laser | |
| | | irradiation | |
| | | mJ/cm² | |
| Printing plate | Annealing step | 0 | 500 |
| Printing plate 3 | No annealing | 42° | 45° |
| Comparative | | | |
| Inventive | 90 min, 430° C., 2.10-5 mBar | 28° | 38° |
| Inventive | 180 min, 430° C., 2.10-5 mBar | 27° | 76° |

### Example 2

A Ti-foil (Goodfellow TI000380 99.6%, 125 μm foil) was cleaned by ultrasound treatment in isopropanol and was subsequently rinsed with water.

In a first step, samples of the cleaned Ti-foil (size: 19 cm×5.5 cm) were etched at 70° C. following the various conditions listed in Table 4.

After the etching step, the different printing plate precursors were anodized at room temperature utilizing a DC voltage of 20 V (Table 4). A titanium counter electrode was used and the distance between the two electrodes was 2.4 cm.

TABLE 4
Etching and anodizing conditions.

| | | | | Anodizing | |
|---|---|---|---|---|---|
| | | | | conditions | |
| Printing | Etching conditions | | | Conc. | |
| plate | Conc. | Conc. | Etching | Oxalic | Anodizing |
| precursor | H₂O₂ | NaOH | time | acid | time |
| (PPP) nr. | mol/l | Mol/l | min | mol/l | min |
| PPP 4 | — | — | — | 0.6 | 1 |
| PPP 5 | — | — | — | 0.6 | 5 |
| PPP 6 | 0.5 | 0.5 | 1 | 0.6 | 1 |
| PPP 7 | 0.1 | 3.0 | 4 | 0.6 | 1 |
| PPP 8 | 0.5 | 3.0 | 4 | 0.6 | 1 |
| PPP 9 | 0.5 | 0.5 | 1 | 0.6 | 5 |
| PPP 10 | 0.5 | 3.0 | 1 | 0.6 | 5 |

The printing plate precursors 4-10 were subsequently exposed with a single beam IR laser diode at 830 nm with a pitch of 7 μm at different powers and drum speeds. The resulting energy densities are given in Table 5.

TABLE 5
Energy densities.

| Laser | Power | Drumspeed | Energy density |
|---|---|---|---|
| Setting | MW | m/s | mJ/cm² |
| 6 | 280 | 4 | 1000 |
| 7 | 200 | 4 | 714 |
| 8 | 140 | 4 | 500 |
| 9 | 280 | 8 | 500 |
| 10 | 200 | 8 | 357 |

After the laser exposure, the plates were immediately mounted on a ABDick 360 wet offset printing press. VAN SON 167 ink (trademark of Van Son) was used together with a fountain solution of 5% G671 (trademark of Agfa-Gevaert) in water. A non-compressible rubber blanket was used and 250 copies were printed on 80 g offset paper. The ink density on the prints were measured using a Gretag Macbeth D19C densitometer (available from Gretag Macbeth AG) and are summarized in Table 6 (ink density after 50 prints) and Table 7 (ink density after 250 prints).

TABLE 6
Ink density after 50 prints.

| Printing | | | | | | |
|---|---|---|---|---|---|---|
| plate (PP) | Density after 50 prints at laser setting* | | | | | |
| nr. | 6 | 7 | 8 | 9 | 10 | Unexposed |
| PP 4 | 1.15 | 1.15 | 1.15 | 1.15 | 1.15 | 1.15 |
| Comparative | | | | | | |
| PP 5 | 1.15 | 1.15 | 1.15 | 1.15 | 1.15 | 1.15 |
| Comparative | | | | | | |
| PP 6 | 0.25 | 0.20 | 0.15 | 0.20 | 0.04 | 0.02 |
| Inventive | | | | | | |
| PP 7 | 0.29 | 0.12 | 0.05 | 0.06 | 0.01 | 0.005 |
| Inventive | | | | | | |
| PP 8 | 1.15 | 1.10 | 1.15 | 1.10 | 1.00 | 0.04 |
| Inventive | | | | | | |
| PP 9 | 0.16 | 0.11 | 0.08 | 0.16 | 0.09 | 0.05 |
| Inventive | | | | | | |
| PP 10 | 0.55 | 0.55 | 0.5 | 0.35 | 0.20 | 0.015 |
| Inventive | | | | | | |

*laser setting see Table 5.

TABLE 7
Ink density after 250 prints.

| Printing | | | | | | |
|---|---|---|---|---|---|---|
| plate (PP) | Density after 250 prints at laser setting* | | | | | |
| nr. | 6 | 7 | 8 | 9 | 10 | Unexposed |
| PP 4 | 1.15 | 1.15 | 1.15 | 1.15 | 1.15 | 1.15 |
| Comparative | | | | | | |
| PP 5 | 1.15 | 1.15 | 1.15 | 1.15 | 1.15 | 1.15 |
| Comparative | | | | | | |
| PP 6 | 0.15 | 0.15 | 0.10 | 0.15 | 0.03 | 0.02 |
| Inventive | | | | | | |
| PP 7 | 0.08 | 0.01 | 0.005 | 0.02 | 0 | 0 |
| Inventive | | | | | | |
| PP 8 | 0.95 | 0.9 | 1.05 | 0.85 | 0.5 | 0 |
| Inventive | | | | | | |
| PP 9 | 0.14 | 0.07 | 0.06 | 0.13 | 0.06 | 0.015 |
| Inventive | | | | | | |
| PP 10 | 0.45 | 0.35 | 0.2 | 0.35 | 0.01 | 0 |
| Inventive | | | | | | |

*laser setting see Table 5.

Tables 6 and 7 show that an etching step followed by an anodization step results in a support having a surface with hydrophilic properties. Upon exposure to infrared light, the ink density values increase. The best results are obtained by the “strongest” etching condition, i.e., longest reaction time and highest concentration of H₂O₂ and NaOH (see inventive printing plate 8). When no etching step is carried out (only an anodization step), the support has a surface with hydrophobic properties (ink density value≧1; see comparative printing plates 4 and 5).

### Example 3

After the printjob, printing plate 8 was cleaned by removing the ink from the plate; the plate cleaner HOWSON NORMAKLEEN RC910 (trademark of Howson Normakleen) was used.

Subsequently, the plate was irradiated for 24 hours with a mercury lamp emitting at 254 nm at 0.5 mW/cm².

After the UV-treatment, half of the plate was irradiated with the IR-laser according to Table 5.

After the laser exposure, the plates were immediately mounted on a ABDick 360 wet offset printing press. VAN SON 167 ink was used together with a fountain solution of 5% G671 (trademark of Agfa-Gevaert) in water. A non-compressible rubber blanket was used and the copies were printed on 80 g offset paper.

The portion of the plate which was not irradiated with the IR-laser showed at print 50 ink density values varying between 0.05 and 0.15. The portion of the plate which was irradiated with the IR-laser showed ink density values of 1.0. The ink density values were measured using a Gretag Macbeth D19C densitometer (available from Gretag Macbeth). This example shows that flood exposure of the printing plate with UV-light results in a precursor which can be re-used in a next cycle of imaging and printing.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A method for making a lithographic printing plate precursor comprising the steps of:
(i) providing a support having a surface including titanium; and
(ii) modifying said surface by producing a hydrophilic oxide of titanium by the steps of:
1) anodizing said surface; and
2) annealing said anodized surface under reduced pressure; wherein
said oxide of titanium is capable of switching from a hydrophilic state to a hydrophobic state upon exposure to at least one of heat and infrared light.

2. The method according to claim 1, wherein the anodizing step is carried out by subjecting the surface at room temperature for a period of about 1 minute to about 8 minutes in an aqueous electrolyte solution at a concentration of about 0.005 mol/l to about 3 mol/l to a DC voltage of about 10 V to about 30 V.

3. The method according to claim 1, wherein the annealing step is carried out for a period of about 60 minutes to about 240 minutes, at a temperature between about 350° C. and about 550° C. and a pressure between about 0.1 kPa to about 1 kPa.

4. The method according to claim 2, wherein the annealing step is carried out for a period of about 60 minutes to about 240 minutes, at a temperature between about 350° C. and about 550° C. and a pressure between about 0.1 kPa to about 1 kPa.

5. A method for making a lithographic printing plate precursor comprising the steps of:
(i) providing a support having a surface including titanium; and
(ii) modifying said surface by producing a hydrophilic oxide of titanium by the steps of:
1) etching said surface; and
2) anodizing said etched surface; wherein
said oxide of titanium is capable of switching from a hydrophilic state into a hydrophobic state upon exposure to at least one of heat and infrared light.

6. The method according to claim 5, wherein the etching step is carried out by immersing the surface in an aqueous solution including one or more alkaline salts for a period of about 0.5 minutes to about 10 minutes at a temperature between about 50° C. and about 100° C.

7. The method according to claim 5, wherein the anodizing step is carried out by subjecting the surface at room temperature for a period of about 1 minute to about 8 minutes in an aqueous electrolyte solution at a concentration of about 0.005 mol/l to about 3 mol/l to a DC voltage of about 10 V to about 30 V.

8. The method according to claim 6, wherein the anodizing step is carried out by subjecting the surface at room temperature for a period of about 1 minute to about 8 minutes in an aqueous electrolyte solution at a concentration of about 0.005 mol/l to about 3 mol/l to a DC voltage of about 10 V to about 30 V.

9. A method for making a lithographic printing plate comprising the steps of:
(i) providing a lithographic printing plate precursor obtained according to the method of claim 1; and
(ii) image-wise exposing the precursor to at least one of heat and infrared light whereby the surface of the precursor switches from a hydrophilic state to a hydrophobic state at exposed areas, thereby producing a lithographic image on said surface.

10. A method for making a lithographic printing plate comprising the steps of:
(i) providing a lithographic printing plate precursor obtained according to the method of claim 5; and
(ii) image-wise exposing the precursor to at least one of heat and infrared light whereby the surface of the precursor switches from a hydrophilic state to a hydrophobic state at exposed areas, thereby producing a lithographic image on said surface.

11. A lithographic printing method comprising the steps of:
(i) providing a lithographic printing plate according to the method of claim 9;
(ii) producing a plurality of printed copies by supplying ink to the printing plate and transferring the ink to paper;
(iii) optionally cleaning the printing plate by removing the ink from the plate;
(iv) erasing the lithographic image by flood-exposing the printing plate to UV light thereby converting hydrophobic areas of the surface to a hydrophilic state; and
(v) re-using the precursor thus obtained in a next cycle comprising steps (i) to (iv).

12. A lithographic printing method comprising the steps of:
(i) providing a lithographic printing plate according to the method of claim 10;
(ii) producing a plurality of printed copies by supplying ink to the printing plate and transferring the ink to paper;
(iii) optionally cleaning the printing plate by removing the ink from the plate;
(iv) erasing the lithographic image by flood-exposing the printing plate to UV light thereby converting hydrophobic areas of the surface to a hydrophilic state; and
(v) re-using the precursor thus obtained in a next cycle comprising steps (i) to (iv).
